(19) United States
(12) Patent Application Publication
(10) Pub. No.: US 2009/0294404 A1
(43) Pub. Date: Dec. 3, 2009

(54) PROCESS FOR CONTROLLING SURFACE WETTABILITY

(76) Inventors: Pascal Colpo, Annecy (FR); Francois Rossi, Cittiglio (IT); Lise-Marie Lacroix, Toulouse (FR); Michael Lejeune, Amiens (FR)

Correspondence Address: CANTOR COLBURN, LLP, 20 Church Street, 22nd Floor, Hartford, CT, 06103, US

(21) Appl. No.: 12/162,660

(22) PCT Filed: Feb. 2, 2006
(86) PCT No.: PCT/EP06/50628

§ 371 Date: Nov. 25, 2008

(51) Int. Cl. B44C 1/22

(52) U.S. Cl. 216/67

(57) ABSTRACT

A process for controlling the wettability of a silicon-containing substrate including
forming a polymer coating over at least one surface region of the silicon substrate, the wettability of which is to be controlled;
inducing a controlled roughness on the at least one surface region by over-etching the polymer coating using a fluorinated plasma;
subjecting the at least one surface region to a surface energy modifying treatment.

### TECHNICAL FIELD OF THE INVENTION

The present invention generally relates to a process for controlling the surface wettability of silicon containing substrates, such as mono- or polycrystalline silicon, quartz, glass or other materials having a high silicon content.

### BRIEF DISCUSSION OF RELATED ART

Wettable or repellent behavior is an important property of surfaces. The wettable or repellent behavior is defined by several parameters among which the surface energy and the surface roughness are dominant [1]. A low surface energy induces a high hydrophobicity; whereas a high surface energy induces a high hydrophilicity [2, 3]. Materials with low surface energy such as carbon fluorine compounds have a maximum contact angle with water about 120 degrees [4]. Surface with higher contact angles can be obtained by using surfaces with controlled roughness [5-8]. Thereby, the studies of the wetting properties of rough surfaces have attracted considerable attention in the last years.

For example, the hydrophobic and repelling solid surfaces have found a large utility on our daily lives: kitchen utensils, glass treatment, etc [9, 10]. More specialized applications include for instance selective surfaces for protein and cells based assays [11]. Development of micro and nanostructured surfaces having a contact angle larger than 150° in mimicking plant surface has retained a lot of attention during the last years. An advantage of these surfaces is e.g. the dramatic reduction of surface contamination and oxidation. Furthermore, these surfaces are needed for protein and cell patterning for micro-arrays development [12, 13]. In connection with these biotechnological applications, nanostructured surfaces having controlled topography and surface wettability have been prepared on silicon substrates (wafers) using electron beam lithography and reactive ion etching techniques.

Unfortunately, these techniques are complex, expensive and rather slow, and therefore not adapted for large scale production of such silicon devices.

### BRIEF SUMMARY OF THE INVENTION

The invention provides an alternative process for controlling the surface wettability of silicon substrates, which is faster and less expensive.

The present invention relates to a process for tailoring the surface wettability of solids having a high silicon content, such as monolithic or polycrystalline silicon (typically silicon wafers), glass, quartz, etc. Solids made from such material having high silicon content, are hereinafter indifferently referred to as silicon-containing substrates or silicon substrates.

According to the present invention, a process for controlling or modifying the surface wettability of a silicon-containing substrate comprises the steps of:

a) forming a polymer coating over at least one surface region of said silicon substrate, the wettability of which is to be controlled;

b) inducing a controlled roughness on the at least one surface region by over-etching the polymer coating using a fluorinated plasma;

c) subjecting the at least one surface region to a surface energy modifying treatment.

The present invention proposes a process allowing to control the surface wettability of selected surface regions on a silicon substrate by tailoring their surface topography and chemical properties. An important aspect of this process is the ability of inducing a controlled roughness in the silicon substrate by a plasma etching procedure (step b), which involves overetching the polymer (i.e. the removal of the polymer layer and partial etching of the silicon substrate underneath) with a fluorinated plasma. The ability of controlling the surface roughness is essential to tailor the wettability character, as it is has a strong influence on the “contact angle” [14, 15, 16].

The plasma assisted surface preparation of the selected substrate regions is then followed by a further step (c) of subjecting the at least one surface region to a surface energy modifying treatment. The purpose of this surface energy modifying treatment is to adjust the chemical composition (rather than the surface roughness and morphology and as in step b) of the substrate surface in order to promote a desired wettability character (i.e. rather repellent or wetting).

The present process is particularly effective to create a high roughness in the silicon surface, which permits to increase the repellent or wetting behaviour of the surfaces.

It shall be noted that present process involves conventional technologies such as polymers coating and plasma etching, which are easy to implement and rather inexpensive. Further, these techniques allow large area surface processing and are highly reproducible.

A particular merit of the present invention is to have observed that when removing a polymer coating with a fluorinated plasma (which is typically used for Si etching but is also known to break carbon-carbon bonds in polymers), a certain roughness profile is initially created in the polymer coating, and this roughness can be transferred to the underlying substrate surface by performing an over-etching of the polymer coating.

Without willing to be bound by theory, an explanation for this surface roughness is that the etching is not regular and some areas of the silicon substrate are rapidly discovered and etched whereas some other areas (with a lower etching rate) remain protected by the polymer (thus acting as a mask). From the morphologic point of view, such process results in a peaks and valleys having shapes and distribution mainly depending on etching time. In thus etching procedure, there are thus residual structures on the top of the peaks (polymer particles and residues), which increase the size of the edges and create extra features of the peaks. The presence of these residual structures (polymer particles) play an essential role in surface roughness control, in particular having regard to their height (roughness) and densities.

The present inventive process permits to produce a high surface roughness on silicon substrates that cannot be obtained when etching a non-coated, flat silicon substrate in the same conditions.

As will be understood by those skilled in the art, the induced roughness will depend on the plasma operating conditions (gas precursor; power; substrate bias) but also on the chemical composition of the polymer coating and of course on the etching time.

Regarding more specifically the etching time, the observed general tendencies are that, for short etching times, the surface has a high roughness without precise shapes and with a high density of peaks and valleys. For intermediate etching times, the difference between peaks and valleys becomes more and more contrasted with sharpening peaks. As the etching times further increases, the surface becomes smoother and more regular. The operating conditions will thus advantageously be determined in function of the materials (substrate, polymer and plasma source), in order to provide the proper roughness to influence, in the desired manner, the wettability character.

As already indicated, in step c) the rough silicon substrate surface is subject to a surface energy modifying treatment that aims at promoting a desired wettability character with regard to a specific liquid. This basically involves modifying or adjusting the chemical surface composition of the treated regions.

In order to have a surface with a water repelling character, a hydrophobic coating can be deposited on the etched surface region. Such hydrophobic coating may comprise a CFₓ layer and can easily be formed by conventional plasma techniques using e.g. C₄F₈ as gas precursor.

To provide a water wetting character to the etched surface regions, a hydrophilic coating can be deposited thereon. Hydrophilic coatings can comprise polyethyleneglycol, acrylic acid or silicon oxide and can be formed by conventional Plasma Enhanced Physical Vapor Deposition technique.

Such hydrophilic or hydrophobic coatings may have a thickness in the range from 10 to 100 nm.

Depending on the intended applications, other types of surface energy modifying treatments can be performed to provide a certain degree of lipophobicity, oleophobicity, etc.

In a preferred embodiment, the fluorinated plasma used for the over-etching step b) is formed from a gas precursor comprising SF₆. Alternatively the gas precursor may comprise CHF₃ or other fluorocarbon gas. Although the gas precursors may consists of 100% SF₆ or CHF3, they can also be mixed together or with other appropriate gases (e.g. O₂ for enhanced selectivity/reactivity), as is known in the art.

Hence, the over-etching step b) is preferably carried out according to the well known reactive ion plasma etching technique.

As already mentioned, the present process allows processing large surface areas. It is e.g. possible to treat glass panes to provide a uniform wettability character over the whole glass surface. In such a case, it suffices to coat the glass pane with a layer of polymer having a substantially uniform thickness. The polymer coating should preferably have a thickness which corresponds to at least twice the desired roughness (mean peak height) which is to be produced during etching step b). For example, in order to produce a surface roughness of about 500 nm, the polymer coating should preferably have a thickness of at least 1 μm.

It shall be further noted that the present process is also compatible with masking and photolithography, which allows production of micro- and nanostructured surfaces on silicon substrates, in particular on silicon wafers and devices for, e.g., application in biotechnology. In such case, the polymer coating is preferably a photoresist resin, which permits surfaces and pattern preparation by photolithography. This thus implies providing the required photoresist coating over the surface regions, the wettability of which is to be controlled.

Accordingly, the photoresist resin may be applied over the whole substrate surface and removed therefrom, except in the surface regions, by means of photolithography. In such case, the surfaces regions covered with the photoresist are etched according to the present process while the other uncovered surface regions will simultaneously be subject to etching, but essentially keep their original (flat) surface roughness.

In any case, surfaces of the substrate other than those surface regions which are meant to be over-etched may protected from during the plasma etching step b), e.g. using conventional masking tools.

A preferred photoresist for use in the present method is Microposit® S1813® PHOTO RESIST (from the Shipley Company, Marlborough, Mass., USA), as it proven particularly satisfying. This photoresist can be easily applied over the substrate by e.g. spincoating. It can advantageously be used where photolithography is involved, but also for very large surfaces were a uniform treatment is desired.

### BRIEF DESCRIPTION OF THE DRAWINGS

The present invention will now be described, by way of example, with reference to the accompanying drawings, in which:

FIG. 1: is a diagram illustrating the principle of a preferred embodiment of the present method;

FIG. 2a-d): are SEM pictures of silicon surface etched by SF₆ plasma during 1 min (a), 2,5 min (b) and 5 min (d). FIG. 2(c) is a magnified view (with an observation angle of 45°) of residual photoresist particles on a peak. The surfaces of pictures a, b and d are 20 μm×20 μm and realized in the conditions of observation. Area of the FIG. 1c is 2 μm×2 μm.

### DETAILED DESCRIPTION OF THE INVENTION

The implementation and effects of present invention will be more apparent from the following detailed description of a preferred embodiment of the present process, which concerns the production of silicon substrates having controlled hydrophobic or hydrophilic character.

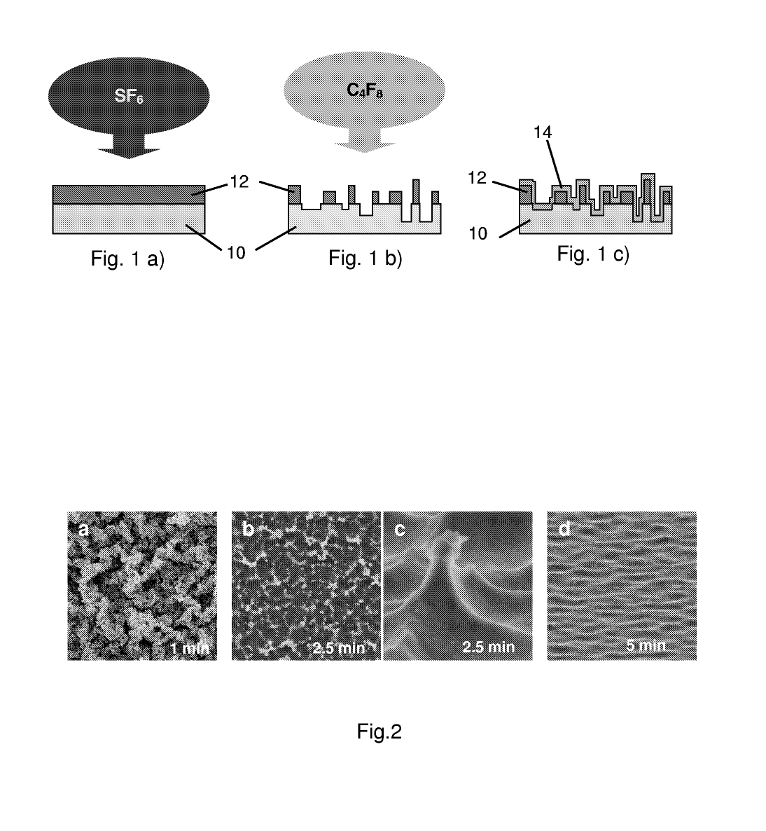

FIG. 1 schematically illustrates this preferred wettability control process. Reference sign 10 in FIG. 1a) designates a silicon substrate that has been coated with a polymer layer 12, preferably a photoresist resin. This coated silicon substrate 10 is treated with a fluorinated plasma (e.g. SF6 in FIG. 1, but could also be e.g. CHF3) so as to carry out an over-etching of the photoresist coating 12, i.e. the removal of the photoresist layer and partial etching of the Si substrate 10 underneath (see FIG. 1b). As will be discussed in more detail below, this etching procedure is not regular and some silicon areas are discovered and etched whereas some other parts are always protected by the photoresist 12 (thus acting as mask). As a result, the silicon surface has an increased roughness (see FIG. 1b), which significantly influences the surface wettability character. Next, the etched silicon substrate 10 is subjected to a surface energy modification (chemical) treatment in order to promote either a wetting or repelling character with regard to a given liquid/fluid. To tailor the wettability of the surface with regard to water, this is advantageously done by depositing a hydrophobic or hydrophilic coating on the rough silicon substrate, preferably also by means of plasma technique. This is illustrated in FIG. 1b) and c) where a hydrophobic layer 14 is formed by means of a plasma of pure C₄F₈ gas precursor. The high roughness of the substrate 10 permits to obtain surfaces with superhydrophobic or superhydrophilic character.

As is conventional in the art, an indication of the hydrophobic or hydrophilic character is given by the value of the so-called “contact angle” (For a given droplet on a solid surface: the contact angle is a measurement of the angle formed between the surface of a solid and the line tangent to the droplet radius from the point of contact with the solid). In this connection, a solid having a contact angle superior to 150° is considered superhydrophobic.

### Example

In the following example, the preparation of silicon wafers with hydrophilic or hydrophobic surfaces will be described in detail.

A. Materials and Experimental Procedure

Silicon wafers (Si (100) diameter 50 mm, resistivity 1-20 Ω·cm, from ITME, Poland) were used as silicon substrate.

The silicon wafers were cleaned and spincoated at a speed of 2000 RPM with the selected photoresist, namely Microposit® S1813® photoresist (Shipley Company). The thickness of the photoresist coating on the Si wafers was about 2.3 μm.

In the present example, the photoresist coated wafers were submitted to “uncontrolled” exposition by exposure to natural light for 24 hours. It may however be noted that exposure of the photoresist is not considered as a requirement in the present embodiment, which may be generally the case when photolithography is not involved.

The previously spincoated wafers were then treated (etched) by means of an inductively coupled plasma discharge. This was performed using the so-called the Magnetic Pole Enhanced ICP (MaPE-ICP) source described in publications [17;18], which are incorporated herein by reference. The inductive mode of the system was used to generate SF₆ plasma discharge (10 mTorr pressure) with a 400 W R.F. power applied to the coil. During etching, the substrate holder was biased at −60V by a secondary 13.56 MHz R.F. supply. Etching time was varied from 1 min to 5 min.

Hydrophobic or hydrophilic layers were then formed on the etched wafers using the same plasma reactor but with different modes, as will be explained below.

For the present experiments, contact angle between substrate surface and 1 μl water droplet was measured with a Digidrop GBX goniometer. The standard deviation of the measurements was less than 1 degree. Surface images were taken using scanning electron microscopy (Variable pressure SEM LEO 435 VP).

B. Results

B1. Fluorinated Plasma Etching

As can be seen in FIG. 2a), the SF₆ reactive plasma etching produces, after a short time, rough features on the photoresist surface. The roughness is created reproducibly and uniformly over the whole substrate area (20 cm²). This effect is believed to result from the fluorinated plasma/polymer interaction, which is of particular efficacy with present combination of Microposit® S1813® photoresist and SF₆ plasma.

For an etching duration lower than 2 minutes, the silicon substrate is etched as well non uniformly. After 2.5 min of etching (FIG. 2b), the photoresist layer is completely removed except for some small residual particles on the top of the silicon peaks (FIG. 2c). These particles are in fact residual masks that create the observed roughness on the silicon surface. For the highest etching duration, linear features organizations are observed and suggest an isotropic etching of the silicon surface.

B2. Hydrophobic Covering

The surface of the 1, 2.5 and 5 min etched wafers have been covered by CFₓ layers using PE-CVD plasma deposition. The CFₓ layers were deposited in the same plasma reactor as for the reactive plasma etching using the 13.56 Mhz capacitive mode. The applied power was fixed to 10 W and lead to a bias voltage of the substrate of −40V. Pure octofluorocyclobutane (C₄F₈) was used as gas precursor at a pressure of 50 mTorr. These operating conditions were selected after an optimization study in order to obtain the highest —CF3 content, since these bonds are considered increasing the hydrophobic behavior of films.

The resulting contact angles are shown in table 1. As can be seen, the contact angle decreases from superhydrophobic values to hydrophobic values as etching time is increased.

TABLE 1

| time (min) | CA (°) |
|---|---|
| 1 | 170 |
| 2.5 | 170 |
| 5 | 116 |

Although not shown herein, SEM measurements of the obtained surfaces show clearly an important deposition of CFₓ on the photoresist residues present on the top of the peaks. These residues are considered to play an important role in the superhydrophobic behavior of the surface by increasing dramatically the amount of contact points between the surface and the liquid. The density of contact point seems to be the key parameter for the elaboration of superhydrophobic surfaces.

For comparative purpose, it may be noted that a film of CFₓ deposited on a conventional flat silicon surface leads to a contact angle of about 105°.

Finally, different properties of these superhydrophobic CFₓ surfaces have been tested. All surfaces have shown a self-cleaning behavior, a contact angle with oil droplet around 120 degrees and an improvement of their buoyancy (the pressure applied in order to sink the surface increases from 38N·m⁻¹ (CFₓ on flat Si) to 48N·m⁻¹).

A particularly remarkable property of the superhydrophobic surfaces is the improvement of the stability in different pH solutions. FTIR spectra analysis have shown that a CFₓ layer deposited on flat silicon wafer is not stable for more than 24 hours in solution at pH 10, and the film is totally delaminated after 1 hour at pH 12. On the contrary, superhydrophobic surface produced according to the present process are very stable even after 200 hours of immersion in solutions with pH varying from 2 to 10.

B3. Hydrophilic Covering

In order to produce silicon wafers with hydrophilic surfaces, a plurality of 1 min etched Si wafers (obtained in the previously described SF₆ plasma etching conditions) have been covered by different hydrophilic materials, namely Polyethyleneglycol (PEG), Acrylic acid (AAc) and silicon oxide (SiOx). For comparative purposes, the same materials has been deposited in same conditions on flat silicon wafers. The deposition conditions are explained below.

PEG films were deposited using a RF capacitive plasma of a pure vapor of diglyme (Diethylene glycol dimethyl ether, (CH3OCH2CH2)2O, Sigma Aldrich) as gas precursor with a power of 1 W at the pressure of 20 mTorr. The contact angle of the PEG films (30 nm thick) deposited on flat substrate was around 50 degrees.

Plasma polymerized acrylic acid layers were deposited by pulsed RF plasma inductive discharge (power 50 W, pressure 50 mTorr, 4 ms time on, 36 ms time off) with deposition conditions described in [19], incorporated herein by reference. The polyacrylic acid films showed a contact angle around 39 degrees on flat wafers.

SiOx layers were deposited with the MaPE-ICP deposition system described above. The gas mixture used for the deposition was composed of 4 sccm hexamethyldisiloxane (MHDSO, (CH3)₃SiOSi(CH₃)₃, Sigma Aldrich), 10 sccm argon and 40 sccm oxygen, with a total pressure of 50 mTorr and a RF power of 450 W. The process produces SiOx layer (with oxygen content x closed to 2) with a good crystalline structure and a contact angle of 52 degrees on flat Si.

The contact angles obtained on the flat silicon wafers (CA Flat) and on the 1 min etched silicon wafers (CA Rg) are summarized in table 2. As can be seen, all the materials deposited on rough surfaces become more hydrophilic than when deposited on flat silicon surface. This is particularly striking for the acrylic acid sample which is clearly superhydrophilic.

TABLE 2

| | CA Flat (°) | CA Rg (°) |
|---|---|---|
| Aac | 38 | 7 |
| SiO₂ | 55 | 44 |
| PEG | 52 | 40 |

C. Conclusion

Roughness on silicon wafer can be designed by a reactive ion etching (RIE) process based on the use of SF₆ as gas precursors (although not presented here, has also be done with CHF₃). A photoresist resin layer acts as a physical mask. The irregular etching of this resin allows the etching of silicon wafer areas whereas other areas remain protected. As shown above, the photoresist etching is not always complete but it is not considered to be a limiting factor for the future applications. The SF₆ plasma over-etching has been performed on large surfaces with similar and reproducible results. The elaborated rough surfaces have been covered by hydrophobic or hydrophilic layers using plasma deposition. The plasma deposition allows a homogenous coating that totally covers the rough surfaces. The rough surfaces covered with CFx layer show interesting properties such as superhydrophobicity and an important increase of their pH stability. The rough surfaces covered with hydrophilic material show an increase of their wettability and even, in the case of an acrylic acid layer, a superhydrophilic behavior. The etching process coupling to the plasma deposition is thus an efficient technique for the elaboration of materials with selected wettability.

1. Process for controlling the wettability of a silicon-containing substrate, comprising the steps of:
a) forming a polymer coating over at least one surface region of said silicon substrate, the wettability of which is to be controlled;
b) inducing a controlled roughness on said at least one surface region by overetching said polymer coating using a fluorinated plasma;
c) subjecting said at least one surface region to a surface energy modifying treatment.

2. Process according to claim 1, wherein said surface energy modifying treatment comprises applying a hydrophobic or hydrophilic coating.

3. Process according to claim 2, wherein said hydrophobic coating comprises CFₓ.

4. Process according to claim 2, wherein said hydrophobic coating comprises polyethyleneglycol, acrylic acid or silicon oxide.

5. Process according to claim 1, wherein step c) comprises treating said at least one surface region with a plasma to form a hydrophilic or hydrophobic coating, said plasma being formed from an appropriate gas precursor.

6. Process according to claim 5, wherein said gas precursor comprises C₄F₈.

7. Process according to any one of claims 2, wherein said hydrophilic or hydrophobic coating has a thickness in the range from 10 to 100 nm.

8. Process according to claim 1, wherein said fluorinated plasma at step b) is formed from a gas precursor comprising SF₆ and/or CHF₃.

9. Process according to claim 1, wherein said polymer is a photoresist film.

10. Process according to claim 9, wherein said photoresist resin is applied on said substrate at step a) by spin coating.

11. Process according to claim 9, wherein at step a) said photoresist resin is applied over said substrate and removed therefrom, except in said at least one surface regions, by means of photolithography.

12. Process according to claim 9, wherein during step b) surfaces of said substrate other than said at least one surface region are protected from said fluorinated plasma.

13. Process according to claim 1, wherein said polymer coating has a thickness of at least 1,5 times, more preferably twice, the desired controlled roughness to be produced.

14. Process according to claim 13, wherein said photoresist coating has a thickness of at least 1 μm.

15. Process according to claim 1, wherein said silicon substrate is made from silicon, quartz or glass.

16. Process according to claim 1, wherein the plasma etching time at step b) is adjusted to produce the desired roughness on said at least one surface region.
